(19) United States
(12) Patent Application Publication
(10) Pub. No.: US 2015/0093114 A1
(43) Pub. Date: Apr. 2, 2015

(54) APPARATUS FOR SUPPRESSING NOISE IN INJECTION-LOCKED LIGHT SOURCE AND WDM-PON SYSTEM PROVIDED WITH SAME

(71) Applicant: Korea Advanced Institute of Science and Technology, Yuseeong-gu, Daejeon (KR)

(72) Inventors: Chang-Hee Lee, Guseong-dong, Yuseong-gu (KR); Sang-Rok Mun, Yonghae-dong, Mokpo-si (KR); Sang-Hwa Yoo, Namtong-dong, Gumi-si, Gyeongbuk (KR); Joon-Young Kim, Pungam-dong, Seo-gu, Gwangjun (KR); Myeonggyun Kye, Gaepo 2-dong, Gangnam-gu, Seoul (KR); Byungil Seo, Pyeongni 4-dong, Seo-gu, Daegu (KR)

(73) Assignee: Korea Advanced Institute of Science and Technology, Daejeon (KR)

(21) Appl. No.: 14/361,464

(22) PCT Filed: Jan. 18, 2012
(86) PCT No.: PCT/KR2012/000450

§ 371 Date: Sep. 10, 2014

(30) Foreign Application Priority Data
Nov. 30, 2011 (KR) 10-2011-0126586
Jan. 18, 2012 (KR) 10-2012-0005880

(51) Int. Cl. H04B 10/50; H04J 14/02

(52) U.S. Cl. CPC H04B 10/50; H04J 14/02
USPC 398/79; 398/194

(57) ABSTRACT

A WDM-PON system configured to perform an asymmetric wavelength division multiplexing and demultiplexing is proposed. A receiving end of WDM-PON system configured to receive a light transmitted from a transmission end including a first wavelength division multiplexer/demultiplexer includes a second wavelength division multiplexer/demultiplexer configured to demultiplex the light received rom the transmission end, where the second bandwidth of wavelength division multiplexer/demultiplexer is substantially greater than that of the first wavelength division multiplexer/demultiplexer.

This application is a National Stage filing under 35 U.S.C. §371 of, and claims priority via, International Application No. PCT/KR2012/000450 for APPARATUS FOR SUPPRESSING NOISE IN INJECTION-LOCKED LIGHT SOURCE AND WDM-PON SYSTEM PROVIDED WITH SAME, filed Jan. 18, 2012, and pursuant to 35 U.S.C. §119 this application also claims the benefit of earlier filing date and right of priority to Korean Patent Application Nos. 10-2011-0126586 and 10-2012-0005880 filed on Nov. 30, 2011 and Jan. 18, 2012, respectively, and the contents of all such applications are hereby incorporated by reference in their entirety.

### FIELD

The teachings in accordance with the exemplary embodiments of this present disclosure generally relate to a noise suppression apparatus, and more particularly to a noise suppression apparatus used in a transceiver of a WDM-PON (Wavelength Division Multiplexed-Passive Optical Network) system, and a WDM-PON system having the noise suppression apparatus.

### BACKGROUND

Generally, a dense WDM-PON (Wavelength Division Multiplexing-Passive Optical Network) may be well understood as a next generation optical network. In WDM-PON technology, an optical transmission module may need to be non-wavelength dependent despite using a plurality of optical wavelengths. Thus, the WDM-PON system (technology) is perceived to be an ultimate alternative to cope with explosively increased data traffic because the WDM-PON system can satisfy an explosively high demand on a wider bandwidth in an access network and is excellent in security.

One of the embodying methods for WDM-PON system is an injection seeded WDM-PON technology. This method has attracted considerable attention as a favorite solution of WDM-PON due to advantages in Giga-byte transmissibility and cost efficiency. However, this method suffers from difficulty in high Giga-byte transmission due to influence by noise of injection-seeded optical source.

In relation thereto, a noise-reducing method using non-linear effect occurring in semiconductors or optical fibers has been proposed. However, the non-linear effect also suffers from disadvantages that require high-cost for high output optical source and management cost due to requirement of light power exceeding a predetermined level for non-linear effect. Thus, a method is demanded capable of effectively and economically reducing noise while a required light power level is low.

### SUMMARY

Therefore, the present disclosure has been made to solve the foregoing disadvantages/problems of the prior art and therefore an object of the disclosure is to provide a noise suppression apparatus for injection seeded optical source configured to suppress noise of seeded light generated from a light (optical) source in a feed forward method, and a WDM-PON (Wavelength Division Multiplexed-Passive Optical Network) system having the noise suppression apparatus.

The present disclosure has been made to solve the foregoing disadvantages/problems of the prior art and therefore another object of the disclosure is to provide a noise suppression apparatus for injection seeded optical source configured to amplify a high frequency bandwidth of a optical source and to suppress noise of seeded light generated from the optical source in a feed forward method, and a WDM-PON (Wavelength Division Multiplexed-Passive Optical Network) system having the noise suppression apparatus.

Technical subjects to be solved by the present disclosure are not restricted to the above-mentioned description, and any other technical problems not mentioned so far will be clearly appreciated from the following description by the skilled in the art. That is, the present disclosure will be understood more easily and other objects, characteristics, details and advantages thereof will become more apparent in the course of the following explanatory description, which is given, without intending to imply any limitation of the disclosure, with reference to the attached drawings.

In one general aspect of the present invention, there is provided a noise suppression apparatus for injection seeded optical source in an optical transmitter configured to receive an injection light from an injection optical source, the apparatus comprising:

an optical coupler configured to receive and split an injection light;
a converter unit configured to convert an optical signal received from the optical coupler to an electrical signal;
an inverter unit configured to invert a phase of the electrical signal converted by the converter unit; and
an optical source driving unit configured to receive the electrical signal inverted in phase by the converter unit and to provide the phase-inverted electrical signal to the optical source.

Preferably, but not necessarily, the optical source may be a reflective optical source.

Preferably, but not necessarily, the optical source may be a non-reflective optical source.

Preferably, but not necessarily, the apparatus may further comprise an amplifier connected between the inverter unit and the optical source driving unit to adjust the intensity of electrical signal phase-inverted by the inverter unit.

Preferably, but not necessarily, the apparatus may further comprise an optical delayer connected between the optical coupler and the optical source to offset a time loss.

Preferably, but not necessarily, the optical source driving unit may adjust a driving current to allow a driving current to grow smaller when a injection light increases, and to allow the driving current to grow larger when the injection light decreases.

Preferably, but not necessarily, the apparatus may further comprise a polarization beam adjuster configured to allow a polarization state of the injection light and that of a light outputted from the optical source to match.

Preferably, but not necessarily, the polarization adjuster may include a polarization beam splitter and a polarization beam controller.

Preferably, but not necessarily, the polarization adjuster may be a polarization beam controller.

In another general aspect of the present disclosure, there is provided a WDM-PON system having a noise suppression apparatus of claims 1 to 9.

In still another general aspect of the present disclosure, there is provided a noise suppression apparatus for injection seeded optical source in an optical transmitter configured to receive an injection light from an injection optical source, the apparatus comprising:

an optical coupler configured to receive and split an injection light;
a converter unit configured to convert an optical signal received from the optical coupler to an electrical signal;
an inverter unit configured to invert a phase of the electrical signal converted by the converter unit;
a bandwidth offset unit configured to amplify a high frequency bandwidth of the electrical signal configured to generate a driving current that drives the optical source; and
an optical source driving unit configured to receive the electrical signal inverted in phase by the converter unit, to generate a driving current configured to drive the optical source by using the signal amplified in high frequency bandwidth by the bandwidth offset unit and to provide the driving current to the optical source.

Preferably, but not necessarily, the optical source may be a reflective optical source.

Preferably, but not necessarily, the optical source may be a non-reflective optical source.

Preferably, but not necessarily, the apparatus may further comprise an amplifier connected between the inverter unit and the optical source driving unit to adjust the intensity of electrical signal phase-inverted by the inverter unit.

Preferably, but not necessarily, the apparatus may further comprise an optical delayer connected between the optical coupler and the optical source to offset a time loss.

Preferably, but not necessarily, the bandwidth offset unit may amplify a signal having a 3-4 GHz bandwidth.

Preferably, but not necessarily, the optical source unit may adjust a driving current to make the driving current smaller when the injection light increases, and to make the driving current greater when the injection light decreases.

Preferably, but not necessarily, the bandwidth offset unit may amplify a data modulated by the optical source driving unit.

In still further general aspect of the present disclosure, there is provided a WDM-PON system including a transmitter having a noise suppression apparatus of any one claim of 1 to 18.

### ADVANTAGEOUS EFFECTS

In an advantageous effect, the present disclosure can promote economy of decreasing an external injection light power in an injection seeded optical source-based WDM-PON by adopting a feed forward noise suppression method configured to operate at a low optical power.

In another advantageous effect, the present disclosure can enhance transmission speed and quality of an optical communication network by reducing noise using a feed forward method.

In still another advantageous effect, the present disclosure can accomplish an easy upgrade from an existing optical communication network by replacing an optical transmission end module because the noise reducing process is performed at an optical communication end.

In still further advantageous effect, the present disclosure can effectively transmit a signal of high frequency bandwidth noiselessly in a wavelength locked optical source-based WDM-PON system by adopting a low optical power operable feed forward method by offsetting bandwidth loss limited to an optical source and transmitting a signal of high frequency bandwidth.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating a noise suppression apparatus for injection seeded optical source according to an exemplary embodiment of the present disclosure;

FIG. 2 is a block diagram illustrating a noise suppression apparatus for injection seeded optical source according to another exemplary embodiment of the present disclosure.

FIG. 3 is a graph illustrating RNI (Relative Noise Intensity) of a noise suppression apparatus for injection seeded optical source according to an exemplary embodiment of the present disclosure;

FIG. 4 is a block diagram illustrating a noise suppression apparatus for injection seeded optical source according to an exemplary embodiment of the present disclosure;

FIGS. 5a and 5b illustrate a spectrum of a signal outputted from an optical source according to prior art;

FIGS. 6a and 6b illustrate a spectrum of a signal outputted from an optical source according an exemplary embodiment of the present disclosure;

FIG. 7 is a block diagram illustrating a WDM-PON system having a noise suppression apparatus for injection seeded optical source according to an exemplary embodiment of the present disclosure; and

FIG. 8 is a block diagram illustrating a WDM-PON system having a noise suppression apparatus for injection seeded optical source according to another exemplary embodiment of the present disclosure.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the example embodiments set forth herein. Accordingly, the described aspect is intended to embrace all such alterations, modifications, and variations that fall within the scope and novel idea of the present disclosure.

Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings.

It will be understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

It will be understood that when an element is referred to as being “connected” or “coupled” to another element, it can be directly connected or coupled to the other elements or intervening elements may be present. In contrast, when an element is referred to as being “directly connected” or “directly coupled” to another element, there are no intervening elements present.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Like numbers refer to like elements throughout and explanations that duplicate one another will be omitted.

Now, the present disclosure will be described in detail with reference to the accompanying drawings.

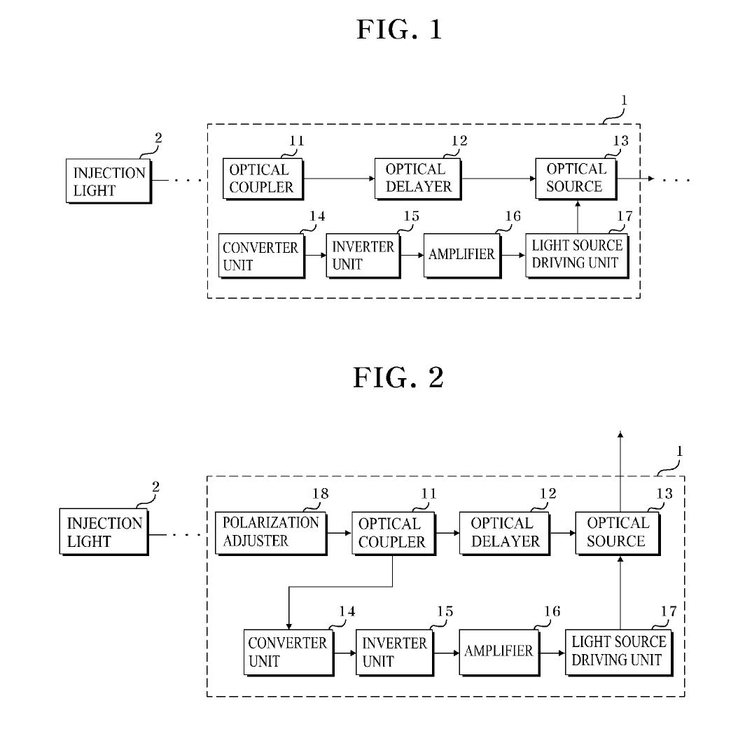

FIG. 1 is a block diagram illustrating a noise suppression apparatus for injection seeded optical source according to an exemplary embodiment of the present disclosure.

Referring to FIG. 1, the noise suppression apparatus for injection seeded optical source according to an exemplary embodiment of the present disclosure generally applied to an optical transmitter 1 includes an optical coupler 11, an optical delayer 12, an optical source 13, a converter unit 14, an inverter unit 15, an amplifier 16 and an optical source driving unit 17.

The optical transmitter 1 applied to the present disclosure receives a light (hereinafter referred to as an injection light) injected from an injection optical source 2 to an optical source 13. The optical coupler 11 splits an injection light by receiving the injection light. The converter unit 14 is connected to the optical coupler 11 to convert a noise of the injection light to an electrical signal. The converter unit 14 may be a photo diode, for example.

The inverter unit 15 is connected to the converter unit 14 to inverse a phase of the noise converted to the electrical signal, and the amplifier 16 is connected to the inverter unit 15 to adjust intensity of phase-inverted noise and output the intensity -adjusted phase-inverted noise. The optical source driving unit 17 is connected to the amplifier 16 to receive the output of the amplifier 16, and provide a current to the optical source 13 using the received output, and to modulate the light source 13.

The optical delayer 12 is connected to the optical coupler 11 to offset a time loss generated in the course of electrical processing. The optical source 13 is connected to the optical delayer 12 to allow injection of injection light, and is driven by the optical source driving unit 17. The optical source 13 may be a reflective optical source, or a non-reflective optical source.

Now, operation of noise suppression apparatus according to the present disclosure will be described in more detail.

An injection light outputted from the injection optical source 2 and transmitted to the optical transmitter 1 is split into two lights through the optical coupler 11. Some of the injection light is transmitted to the converter unit 14. The converter unit 14 converts a noise of the injection light to an electrical signal by detecting the noise of the injection light. The noise converted to the electrical signal by the converter unit 14 is converted to a noise of inverted phase, adjusted in intensity by the amplifier 16 and transmitted to the optical source driving unit 17.

The optical source driving unit 17 receives the noise that is converted to reverse phase, where the noise is combined by a modulation current and a driving current, and outputs the combined noise to the optical source 13. The optical source driving unit 17 adjusts the driving current in such a manner that the driving current grows smaller when the injection light increases by the intensity of noise and the driving current decreases when the injection light decreases.

Meantime, another output of the optical coupler 11 is injected to the optical source 13, where the noise is offset because noises are operated to mutually-offset directions, and a noise of light injected from the optical source 13 and a noise transmitted from the optical source driving unit 17 are mutually inversely phased.

It should be apparent to the skilled in the art that the noise-suppressed output light of the optical source 13 becomes an output light of an optical transmitter (Tx) via the optical coupler when the optical source 13 is a reflection type optical source, while the light is outputted without being reflected and not via the optical coupler 11, when the optical source 13 is a non-reflection type optical source.

FIG. 2 is a block diagram illustrating a noise suppression apparatus for injection seeded optical source according to another exemplary embodiment of the present disclosure.

Referring to FIG. 2, the noise suppression apparatus for injection seeded optical source according to another exemplary embodiment of the present disclosure generally applied to an optical transmitter 1 includes an optical coupler 11, an optical delayer 12, an optical source 13, a converter unit 14, an inverter unit 15, an amplifier 16, an optical source driving unit 17 and a polarization beam adjuster 18.

The exemplary embodiment of the present disclosure illustrated in FIG. 2 further includes a polarization beam adjuster 18. Description of other elements than the polarization beam adjuster 18 will be omitted, as other elements than the polarization beam adjuster 18 have the same functions as those in FIG. 1.

The polarization beam adjuster 18 receives an injection light from an injection optical source 2 to match a polarization state of the injection light to that of a light outputted from an optical source 13. The polarization beam adjuster may include a polarization beam splitter or may include a polarization beam controller.

In comparison between the exemplary embodiment of FIG. 1 and the exemplary embodiment of FIG. 2, the exemplary embodiment of FIG. 2 intends to offset the polarization state when the polarization state of injection light source 2 and that of the injected seeded optical source 13 are different. The injection light outputted from the injection light source 2 is adjusted to be matched to the polarization state of the optical source 13 and then inputted to the optical coupler 11. Other operational principles are same as those of FIG. 1.

A part of light including the intensity of noise injected to the optical transmitter from outside in the noise suppression apparatus according to the present disclosure is converted to a current, and then converted to a phase-inverted current and amplified. This current is added to a modulation current of the optical source and injected to the optical source whereby an optical noise can be economically suppressed.

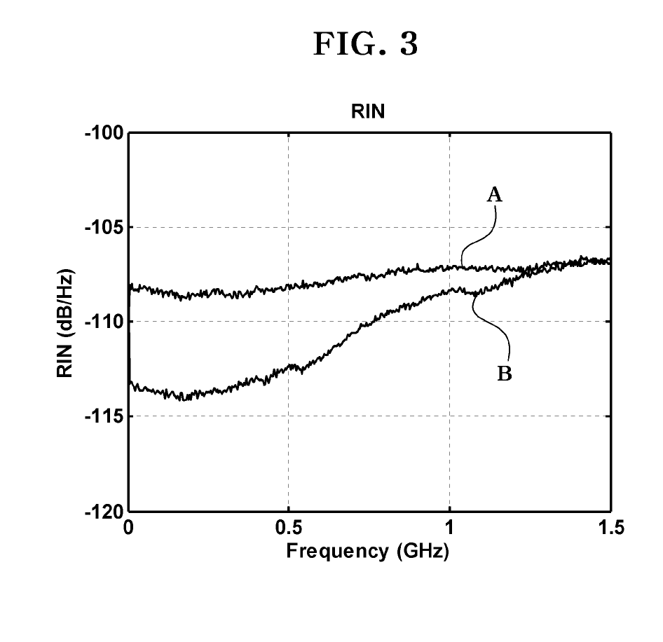

FIG. 3 is a graph illustrating RNI (Relative Noise Intensity) of a noise suppression apparatus for injection seeded optical source according to an exemplary embodiment of the present disclosure, where the RNI indicates distribution of noise for unit intensity of each frequency, and where A defines an RIN prior to application of the noise suppression apparatus according to the present disclosure and B defines an RIN after application of the noise suppression apparatus according to the present disclosure. As illustrated in the graph, it can be noted that the intensity of noise is reduced by the noise suppression apparatus.

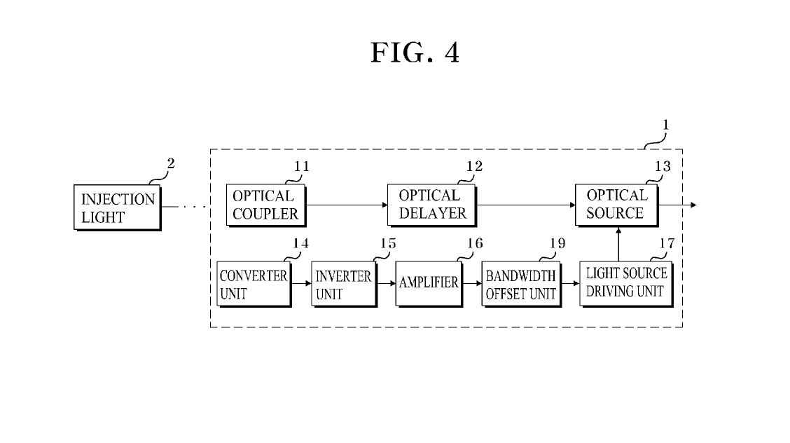

FIG. 4 is a block diagram illustrating a noise suppression apparatus for injection seeded optical source according to an exemplary embodiment of the present disclosure.

Referring to FIG. 4, the noise suppression apparatus for injection seeded optical source according to an exemplary embodiment of the present disclosure generally applied to an optical transmitter 1 includes an optical coupler 11, an optical delayer 12, an optical source 13, a converter unit 14, an inverter unit 15, an amplifier 16, a bandwidth offset unit 19 and an optical source driving unit 17.

The optical transmitter 1 applied to the present disclosure receives a light (hereinafter referred to as an injection light) injected from an injection optical source 2 to an optical source 13. The optical coupler 11 splits an injection light by receiving the injection light. The converter unit 14 is connected to the optical coupler 11 to convert a noise of the injection light to an electrical signal. The converter unit 14 may be a photo diode, for example.

In order to transmit a signal of high Giga bit, the bandwidth offset unit 19 amplifies a high frequency bandwidth of a signal to be provided by the optical source driving unit to the optical source 13, and offsets loss of high frequency bandwidth caused by limited bandwidth of the optical source 13.

A conventionally used RSIA (Reflective Semiconductor Optical Amplifier) or a optical source such as F-D LP (Fabry-Perot Laser Diode) is limited in bandwidth to 3-4 GHz. Thus, in order to transmit a signal of more than 3-4 GHz, when the bandwidth offset unit 17 according to the present disclosure amplifies a signal of high frequency bandwidth and transmits the amplified signal, it is possible to offset the loss of high frequency bandwidth. The bandwidth offset unit 19 preferably amplifies a signal of more than 3-4 GHz, for example, in the optical source 13, and the bandwidth offset unit 19 may be an equalizer, for example.

Although the exemplary embodiment of the present disclosure has explained the bandwidth offset unit 19 amplifies a signal of the feed forward optical source 13, the present disclosure is not limited thereto, it is possible to amplify data modulated by the optical source driving unit 17, in addition to the signal of the feed forward optical source 13 by being provided into the optical source driving unit 17.

The optical source driving unit 17 receives a phase-inverted noise from the amplifier 16 and receives a bandwidth-offset signal from the bandwidth offset unit 19, provides a current to the optical source 13 using the same and modulates a signal provided to the optical source 13.

The optical delayer 12 is connected to the optical coupler 11 to offset a time loss generated in the course of electrical processing. The optical source 13 is connected to the optical delayer 12 to allow injection of injection light, and is driven by the optical source driving unit 17. The optical source 13 is not limited to the exemplary embodiment thus described, and may be a reflective optical source, or a non-reflective optical source.

Now, an operation of the noise suppression apparatus will be described in more detail of FIG. 4.

An injection light outputted from the injection optical source 2 and transmitted to the optical transmitter 1 is split into two lights through the optical coupler 11. A part of the injection light is transmitted to the converter unit 14. The converter unit 14 converts a noise of the injection light to an electrical signal by detecting the noise of the injection light. The noise converted to the electrical signal by the converter unit 14 is converted to a noise of inverted phase by the inverter unit 15, adjusted in intensity by the amplifier 16 and transmitted to the bandwidth offset unit 19.

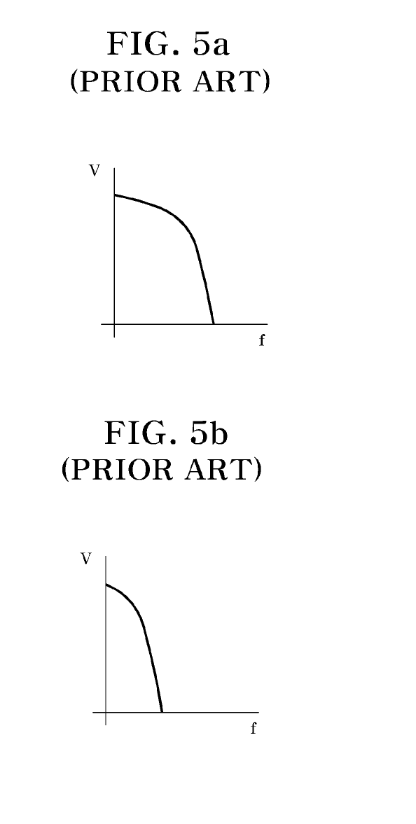

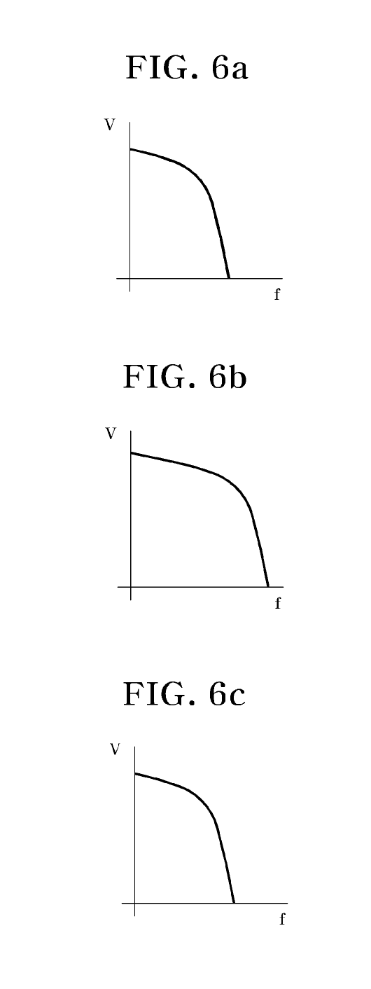

FIGS. 5a and 5b illustrate a spectrum of a signal outputted from an optical source according to prior art, and FIGS. 6a and 6b illustrate a spectrum of a signal outputted from an optical source according an exemplary embodiment of the present disclosure, where FIGS. 5a and 6a illustrate a spectrum of an electrical signal inputted from the optical source.

In the conventional system, an electrical signal inputted from the optical source loses a high frequency bandwidth component to be outputted in a biased signal as illustrated in FIG. 5b. However, when the bandwidth offset unit 19 amplifies the high frequency bandwidth to output a signal amplified as shown in FIG. 6a according to the present disclosure and the signal amplified in the high frequency bandwidth by the bandwidth offset unit 19 is provided to the optical source 13 through the optical source driving unit 17, it can be noted that a signal free from distortion can be outputted.

The optical source driving unit 17 receives a phase-inverted noise from the amplifier 16, and receives a high frequency bandwidth-amplified signal from the bandwidth offset unit 19, combines a modulation current generated using the high frequency bandwidth-amplified signal with a driving current, and outputs the combined to the optical source 13. The optical source driving unit 17 adjusts a driving current in such a manner that the driving current decreases when an injection light increases due to noise, and the driving current increases when the injection light decreases.

Meanwhile, another output of the optical coupler 11 is injected to the optical source 13, where the noise is offset because noises are operated to mutually-offset directions, and a noise of light injected from the optical source 13 and a noise transmitted from the optical source driving unit 17 are mutually inversely phased. Furthermore, because a current injected to the optical source 13 is a current amplified in high frequency bandwidth, noise in the high frequency bandwidth can be effectively reduced.

It should be apparent to the skilled in the art that the noise-suppressed output light of the optical source 13 becomes an output light of an optical transmitter (Tx) via the optical coupler when the optical source 13 is a reflection type optical source, while the light is outputted without being reflected and not via the optical coupler 11, when the optical source 13 is a non-reflection type optical source.

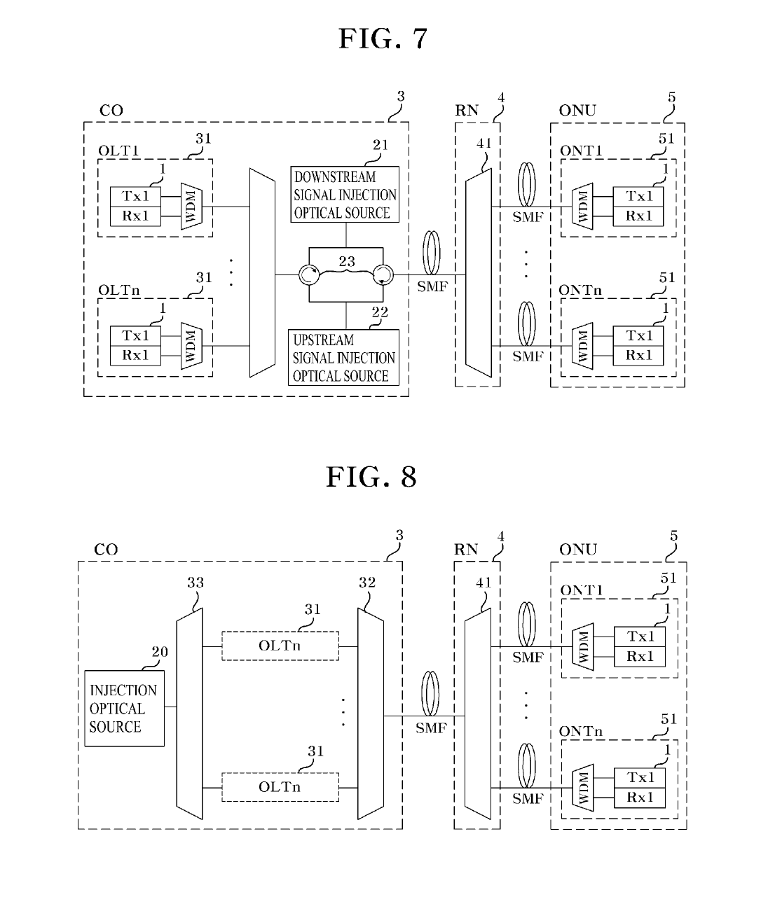

FIG. 7 is a block diagram illustrating a WDM-PON system having a noise suppression apparatus for injection seeded optical source according to an exemplary embodiment of the present disclosure.

Referring to FIG. 7, the WDM-PON system having a noise suppression apparatus for injection seeded optical source according to an exemplary embodiment of the present disclosure includes a CO (Central Office, 3), a RN (Remote Node, 4) and ONU (Optical Network Unit, 5).

The CO 5 includes an injection optical source 3, where the injection optical source 13 is classified into a downstream signal injection optical source 21 and an upstream signal injection optical source 22. Furthermore, the optical source 2 may include a circulator 23.

The circulator 23 is an element having three ports, where a signal inputted to a first port is outputted to a second port, and a signal inputted to the second port is outputted to a third port. Furthermore, the CO 3 includes a plurality of OLTs (Optical Line Terminal, 31) and a first wavelength division multiplexer/demultiplexer 32. The OLT 31 includes optical transmitters 1 having the noise suppression apparatus according to the present disclosure (indicated as ‘Tx1’ . . . ‘Txn’ in FIG. 4) and a WDM (Wavelength Division Multiplexer).

The RN 4 is connected to the CO 3 through an SMF (Single Mode Fiber), and includes a second wavelength division multiplexer/demultiplexer 41 as a router installed in an apartment administration office.

The ONU 5 is connected to the RN 4 via SMF, and includes an ONT (Optical Network End51) as a unit provided to each household. The ONT 51 which is an OLT 31 at a user side includes an optical transmitter 1 formed with a noise suppression apparatus according to the present disclosure, an optical receiving end and a WDM. A signal directed to the ONU 5 is a downstream signal and a signal directed to the CO 3 from the ONU 5 is an upstream signal.

Now, operation of the WDM-PON system according to the present disclosure will be described. The system in FIG. 7 is symmetrically configured such that description will be made based on downstream.

A light of broadband spectrum outputted from the downstream injection optical source 21 is inputted to a first port of the circulator 23, outputted to a second port and transmitted to the second wavelength division multiplexer/demultiplexer 41 of the RN 40 via SMF. The second wavelength division multiplexer/demultiplexer 41 divides the received light to wavelength of each channel, whereby noise of injection light is greatly increased. Successively, the wavelength-divided light is inputted to WDM of ONT 51. An L band (1565 nm˜1625 nm) is generally used for the downstream signal. The WDM of ONT 51 transmits a wavelength-different L band light to the optical transmitter 1 and transmits a light of another wavelength to an optical receiver Rx. Thus, the light received by the ONT 51 is injected to the optical transmitter 1 according to the present disclosure.

The injection light injected to the optical transmitter 1 is divided to two by the optical coupler 11. One light is transmitted to the optical source 13 and the other light is converted to an electrical signal by the converter unit 14.

The inverter unit 15 reverses the phase, and the amplifier 16 adjusts the size of phase-inverted signal. The optical source driving unit 17 receives a phase inverted noise to combine the noise with a modulated current and a driving signal, and outputs to the optical source 13.

Alternatively, the inverter unit 15 reverses the phase, and the amplifier 16 adjusts the size of phase-inverted signal. The optical source driving unit 17 receives a phase inverted noise to combine a modulated current generated by using noise phase-inverted by the bandwidth offset unit 19 and a driving signal, and outputs to the optical source 13.

The optical source 13 according to the exemplary embodiment of the present disclosure is actually operated as an optical amplifier. A driving signal and a gain in an optical source are substantially proportional, such that the gain decreases when the injection light increases, and the gain increases when the injection light decreases. Thus, it is possible to smooth an output light after passing through the optical source 13.

Thereafter, the light suppressed in noise by passing through the reflective light source 13 of the optical transmitter 1 is transmitted to the SMF by the second wavelength division multiplexer/demultiplexer 41 via the WDM of the ONT 51, and transmitted to the receiver Rx via the first wavelength division multiplexer/demultiplexer 32.

FIG. 8 is a block diagram illustrating a WDM-PON system having a noise suppression apparatus for injection seeded optical source according to another exemplary embodiment of the present disclosure.

The WDM-PON system of FIG. 5 is different from the WDM-PON of FIG. 4 in terms of position of optical source 20, but the principle is same as that of WDM-PON system according to the exemplary embodiment of FIG. 4.

A third wavelength division multiplexer/demultiplexer 33 divides the light outputted from a multiple wavelength injection optical source 20 and provides the divided light to the OTL 31. Based on the downstream signal, the light outputted from the injection optical source 20 is divided by the third wavelength division multiplexer/demultiplexer 33 to be injected to the optical transmitter 1 of the OLT 31, and received by the optical receiver Rx of the ONT 51 via the first wavelength division multiplexer/demultiplexer 32, the SMF and the second wavelength division multiplexer/demultiplexer 41. Other descriptions are omitted because description is same as those in FIG. 7.

The previous description of the present disclosure is provided to enable any person skilled in the art to make or use the inventive disclosure. Various modifications to the disclosure will be readily apparent to those skilled in the art, and the generic principles defined herein may be applied to other variations without departing from the spirit or scope of the disclosure. Thus, the present disclosure is not intended to limit the examples described herein, but is to be accorded the widest scope consistent with the principles and novel features disclosed herein.

1. A noise suppression apparatus for injection seeded optical source in an optical transmitter configured to receive an injection light from an injection optical source, the apparatus comprising:
an optical coupler configured to receive and split an injection light;
a converter unit configured to convert an optical signal received from the optical coupler to an electrical signal;
an inverter unit configured to invert a phase of the electrical signal converted by the converter unit; and
an optical source driving unit configured to receive the electrical signal inverted in phase by the converter unit and to provide the phase-inverted electrical signal to the optical source.

2. The apparatus of claim 1, wherein the optical source is a reflective optical source.

3. The apparatus of claim 1, wherein the optical source is a non-reflective optical source.

4. The apparatus of claim 1, further comprising an amplifier connected between the inverter unit and the optical source driving unit to adjust the intensity of electrical signal phase-inverted by the inverter unit.

5. The apparatus of claim 1, further comprising an optical delayer connected between the optical coupler and the optical source to offset a time loss.

6. The apparatus of claim 1, wherein the optical source driving unit adjusts a driving current to allow a driving current to grow smaller when a injection light increases, and to allow the driving current to grow larger when the injection light decreases.

7. The apparatus of claim 1, further comprising a polarizing beam adjuster configured to allow a polarization state of the injection light and that of a light outputted from the optical source to match.

8. The apparatus of claim 7, wherein the polarization beam adjuster includes a polarization beam splitter and a polarization beam controller.

9. The apparatus of claim 7, wherein the polarization beam adjuster is a polarization beam controller.

10. A WDM-PON system having a noise suppression apparatus of claim 1.

11. A noise suppression apparatus for injection seeded optical source in an optical transmitter configured to receive an injection light from an injection optical source, the apparatus comprising:
an optical coupler configured to receive and split an injection light;
a converter unit configured to convert an optical signal received from the optical coupler to an electrical signal;
an inverter unit configured to invert a phase of the electrical signal converted by the converter unit;
a bandwidth offset unit configured to amplify a high frequency bandwidth of the electrical signal configured to generate a driving current that drives the optical source; and
an optical source driving unit configured to receive the electrical signal inverted in phase by the converter unit, to generate a driving current configured to drive the optical source by using the signal amplified in high frequency bandwidth by the bandwidth offset unit and to provide the driving current to the optical source.

12. The apparatus of claim 11, wherein the optical source is a reflective optical source.

13. The apparatus of claim 11, wherein the optical source is a non-reflective optical source.

14. The apparatus of claim 11, further comprising an amplifier connected between the inverter unit and the optical source driving unit to adjust the intensity of electrical signal phase-inverted by the inverter unit.

15. The apparatus of claim 11, further comprising an optical delayer connected between the optical coupler and the optical source to offset a time loss.

16. The apparatus of claim 11, wherein the bandwidth offset unit amplifies a signal having a 3-4 GHz bandwidth.

17. The apparatus of claim 11, wherein the optical source unit adjusts a driving current to make the driving current smaller when the injection light increases, and to make the driving current greater when the injection light decreases.

18. The apparatus of claim 11, wherein the bandwidth offset unit amplifies a data modulated by the optical source driving unit.

19. A WDM-PON system including a transmitter having a noise suppression apparatus of claim 1.
